(19) United States
(12) Patent Application Publication
(10) Pub. No.: US 2026/0267664 A1
(43) Pub. Date: Sep. 10, 2026

(54) METHOD FOR TRANSFERRING CONTROL OVER MULTI-OWNED COMPUTING ENVIRONMENTS

(71) Applicant: Robert Bosch GmbH, Stuttgart (DE)

(72) Inventors: Sven TRIEFLINGER, Renningen (DE); Sebastian BECKER, Ludwigsburg (DE); Pradeep M. PAPPACHAN, Pittsburgh, PA (US); Shalabh JAIN, Pittsburgh, PA (US); Stefan GEHRER, Pittsburgh, PA (US)

(21) Appl. No.: 19/073,905

(22) Filed: Mar. 7, 2025

(51) Int. Cl. G06F 9/445

(52) U.S. Cl. CPC G06F 9/44505

(57) ABSTRACT

A method for performing a transfer of a multi-owned computing environment (MOCE) includes, using one or more computing devices, establishing a confidential computing system in a trusted execution environment (TEE) under control of a source controller configured to implement a transfer agent, launching a target controller separate from the source controller, in response to receiving a proposal to transfer control of the confidential computing system from the source controller to the target controller, determining whether a predetermined number of participating parties (PPs) associated with the confidential computing system approve of the transfer of control, in response to determining that the predetermined number of PPs approve of the transfer of control, launching the transfer agent at the source controller, and transferring control of the MOCE to the target controller using the transfer agent.

### TECHNICAL FIELD

The present disclosure relates to multi-party computing environments.

### BACKGROUND

Various collaborative processes (e.g., digital cleanrooms, collaborative learning for AI, etc.) involve multiple entities/parties. In one example, distributed software integrations and build processes may involve multiple entities/parties independently developing and testing respective portions (e.g., software modules) of a software application and then integrating the various software modules to build the application within a computing environment (e.g., as implemented in a cloud computing system). For example, in the automotive industry, original equipment manufacturers (OEMs) and suppliers may collaborate to develop software applications that are executed on embedded systems inside vehicles. This model of collaboration may include each entity separately developing and testing some portion of the software application to defined specifications (e.g., respective requirements, application program interface (API) specifications, etc.) and eventually integrating the various software portions before final testing and implementation. In some examples, a computing environment is configured to be set up and operated by a single party or entity with full administrative power.

### SUMMARY

A method for performing a transfer of a multi-owned computing environment (MOCE) includes, using one or more computing devices, establishing a confidential computing system in a trusted execution environment (TEE) under control of a source controller configured to implement a transfer agent, launching a target controller separate from the source controller, in response to receiving a proposal to transfer control of the confidential computing system from the source controller to the target controller, determining whether a predetermined number of participating parties (PPs) associated with the confidential computing system approve of the transfer of control, in response to determining that the predetermined number of PPs approve of the transfer of control, launching the transfer agent at the source controller, and transferring control of the MOCE to the target controller using the transfer agent.

Other embodiments include systems, one or more processors or processing devices, or other circuitry configured to implement functions corresponding to the principles of the present disclosure.

### BRIEF DESCRIPTION OF THE DRAWINGS

FIG. 1 illustrates an example cooperative computing environment.

FIG. 2 illustrates an example cooperative computing environment including a management gateway.

FIG. 3 illustrates an example confidential computing system configured to perform a multi-owned computing environment (MOCE) transfer process according to the systems and methods of the present disclosure.

FIG. 4 is a block diagram of an example computing device configured to implement functions of the systems and methods of the present disclosure.

FIG. 5 illustrates steps of an example method for performing an MOCE transfer process in a confidential computing environment according to the principles of the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative bases for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical application. Various combinations and modifications of the features consistent with the teachings of this disclosure, however, could be desired for particular applications or implementations.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions.

In some examples, a computing environment is configured to be set up and operated by a single party or entity with full administrative power. If such an environment is used in collaborative or cooperative settings in which multiple entities contribute potentially sensitive or valuable digital assets (e.g., data, algorithms) to the overall system, the power of that single party to change the environment at any time in any way is problematic. For example, collaborating entities may not trust each other with respective intellectual property (IP), an entity with administrative power may now know assets (e.g., intellectual property) of other entities, etc. One established method for resolving this issue is to delegate the setup and operation of the computing environment (CE) to a trusted (third) party (TP). Trust extended to the TP is based on an assumption that the TP does not have interest in the digital assets that would create an incentive to extract or modify the digital assets, or the TP may be bound by various contracts or agreements not to disclose assets or other information. Further, capability of the TP to operate the environment in a secure way to prevent internal and external security threats is assumed.

FIG. 1 illustrates an example cooperative computing environment (CE) 100. For example, the CE 100 includes a computing system 104 (e.g., a computing environment implemented in a cloud computing system, one or more servers or distributed computing devices, a computing cluster, etc.) accessible by multiple entities that are users or providers of digital assets within the CE 100, which, in some examples, may correspond to developer entities 108. The entities 108 may independently develop and test respective portions (e.g., workloads 112) of a software application within the computing system 104.

If one or more of the entities 108 contribute potentially sensitive or valuable digital assets to the computing system 104, it may not be desirable for any one of the entities 108 to control the CE 100. Accordingly, in some examples, the CE 100 is configured to be set up and operated by a single party or entity with full administrative power. For example a trusted third party (TP) 116 may be assigned full administrative power, which may include access to a policy engine 120 configured to control setup of the computing system 104, changes to the computing system 104 subsequent to setup, etc. In some examples, the trusted TP 116 may be one of the entities 108. However, trust extended to the TP 116 is based on an assumption that the TP 116 does not have interest in the digital assets that would create an incentive to extract or modify the digital assets. Further, capability of the TP 116 to operate the CE 100 in a secure way to prevent internal and external security threats must be assumed by the entities 108.

In some examples, advanced privacy-preserving computing techniques are used to establish a confidential CE (CCE) that provides a consensus-based setup and management mechanism for the CE that performs a management operation only if all contributing entities agree. These systems replace the trust-based operations model for multi-party CEs with a model that technically enforces the rules of cooperation within the CE and allows auditing of the enforcement process. Example systems and methods for establishing a confidential CE in this manner are described in more detail in U.S. patent application Ser. No. 18/594,777, filed 4 Mar. 2024, the entire contents of which are incorporated herein by reference.

For example, a mechanism is provided for setting up and operating a multi-owned computing environment (MOCE) (e.g., a CE that is set up and operated under the governance of more than one party/entity). The MOCE includes an interface for admitting the execution of management operations of a cluster (e.g., one or more build servers, computing devices, etc. used by multiple parties to implement a software build) only if a consensus among the owners of the environment is reached that an operation is permitted. Integrated policy engines implement versatile and flexible operation management (e.g., to define which operations can be performed and by which entities, in which circumstances, etc.). A sandboxing mechanism for workloads of the respective entities is executed within the MOCE and allows for tight control over what a workload is permitted to do (e.g., accessing other digital assets, opening network connections, etc.), and which resources the workload is permitted to consume (e.g., main memory, CPU/GPU time, etc.). The MOCE may further include a tamper-proof auditing mechanism to track which management operations have been performed by which entities (and when the management operations were performed) and a backup and recovery mechanism.

As used herein and described below in more detail, “CMI” refers to a consensus-driven management interface. “Participating party” (PP) refers to a party participating in a collaboration enabled by the principles of the present disclosure on the CE. The terms “party” and “entity” may be used interchangeably. A “computing environment” (CE) refers to the environment used by the PPs for collaboration, such as on a software build. Although described with respect to a collaboration for a software build, in other examples the principles of the present disclosure may be implemented for other types of collaborative CEs. A “hosting party (HP) refers to the party that instantiates the CE on its own or third-party infrastructure. “Trusted execution environment (TEE) refers to one example environment that is secure in accordance with confidential computing techniques that implement hardware protection techniques. A TEE provides the ability to establish trust in the TEE by a process called remote attestation (RA). A controller TEE is a TEE that hosts the control logic implementing the CMI and performs the management actions on the CE when consensus is reached. A controller TEE is implemented using one or more computing devices, processors or processing devices, etc.

Computing environments according to the present disclosure are configured to implement a consensus-driven management interface (CMI or CMMI) or consensus-driven management API (CAPI). A CMI or CAPI according to the present disclosure is an interface over which PPs can make a proposal or request for invoking a management functionality exposed over the interface. In an example embodiment, to set up the CE, the hosting party (HP) launches a TEE, referred to herein as the controller TEE (CTEE, or “controller in a trusted execution environment”), on a computing device or platform configured to provide the required confidential computing support. The computing device can be a public cloud provider, an on-premises datacenter (e.g., local to one or more of the entities), or combinations thereof. The CMI is implemented via a CTEE, which may be referred to as a management gateway.

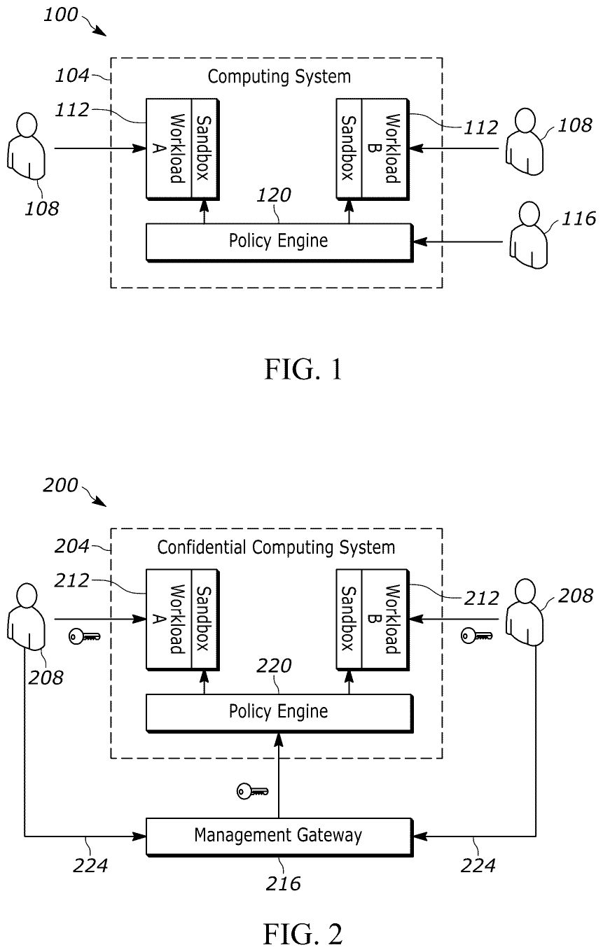

FIG. 2 illustrates an example cooperative computing environment (CE) 200 configured to implement a CMI. For example, the CE 200 includes a confidential computing system 204 (e.g., a computing environment implemented in a cloud computing system, one or more servers or distributed computing devices, a computing cluster, etc.) accessible by multiple developer entities (e.g., PPs, client computing devices, etc.) 208. The entities 208 may independently develop and test respective portions (e.g., workloads 212) of a software application within the computing system 204. In an example, the computing system 204 implements or is implemented by a confidential Kubernetes (K8s) cluster.

The CE 200 is configured to remove the need for a trusted TP by using advanced privacy-preserving computing techniques to establish an interface to the CE 200 that provides a consensus-based setup and management mechanism for the CE 200 that performs a management operation only if all contributing entities agree.

For example, the CE 200 is configured to implement a trusted, consensus-based management gateway 216. In an example, the management gateway 216 is configured to implement and/or operate in accordance with a TEE. The management gateway 216 is used to set up and operate the CE 200 (e.g., via management and control of policy engine 220). The computing system 204 is further configured to implement other components of the systems and methods described above, such as the operating system, controller software module, etc.

The management gateway 216 is configured to function as an interface for admitting the execution of management operations in the computing system 204 only if a consensus among the entities 208 is reached that an operation is permitted. In some examples, “consensus” may require agreement from all entities. In other examples, consensus may be achieved by agreement from a subset of all entities (e.g., a number of entities less than a total number of the entities), by reaching a threshold value (e.g., a threshold value corresponding to a combination of weighted votes or values from respective entities), etc. For example, the management gateway 216 (in communication with and responsive to the controller software module implemented on/by the computing system 204) is configured to implement all or portions of the CMI or CAPI described herein. Although shown separate from the computing system 204 (e.g., “off-cluster”), in other examples the management gateway 216 may be integrated with (e.g., located within) the computing system 204.

Accordingly, the management gateway 216 is configured to provide an interface over which the entities 208 can make a proposal or request for invoking a management functionality (e.g., via respective control paths 224). For example, any proposals or requests are provided from the entities 208 to the management gateway 216 and kept in a pending state until all (or a defined subset) of the entities 208 have approved the proposal in accordance with the systems and methods described herein.

CTEEs (e.g., CTEEs implemented within the CE 200) typically include software (SW) with a considerable degree of complexity and as such are subject to continuous updates and other maintenance operations. Performing those operations is necessary for operation of the CE 200. As one example, when common vulnerabilities and exposures (CVE) for software components used in the CTEE are disclosed, patches are be applied. As another example, when new features are to be added to the CTEE, updating constituent software components may be required.

However, in some examples, such as in the CE 200 described above in FIG. 2, updates to software components may be prohibited by design since updates can potentially introduce malicious code to the CTEE that undermines the security guarantees of the system. A CTEE that is irreversibly configured (i.e., not able to be updated) in this manner may be referred to as an imprinted CTEE. Prohibiting or preventing updates severely limits the applicability of CEs implementing imprinted CTEEs since long term operation of a CTEE and corresponding managed MOCEs requires regular updates to keep the system secure in view of newly discovered security vulnerabilities and newly required system functionality.

Accordingly, systems and methods according to the present disclosure implement a cooperative computer environment (CE) that allows CTEEs to be updated without compromising the security of the end-to-end system. The systems and methods described herein provide a structured and automated subsystem for transferring MOCEs from one CTEE to another (e.g., from a source or current CTEE to a target CTEE) using a CMI, such as the CMI of a CE configured as described above in FIG. 2.

In an example CE such as the CE 200 describe above, any party connecting to the CTEE may establish trust in the CTEE by verifying the measurement of corresponding software, configuration, etc. In some examples, the CTEE includes an identity management module configured to generate public-private key pairs that can be used by the CTEE for communication with external entities or internally between different entities. As one example, for each key pair, the identity management module generates a X.509 certificate chain rooted in the attestation report of the CTEE module. The chain can be verified by any party resulting from a CTEE with a specific measurement running in a confidential computing environment.

In scenarios where CTEE functionality is distributed over multiple nodes, the identity management module can further include additional information such as initial topology as well as the software measurement within the certificate chain. In such a scenario, the identity management module can inject public-private key pairs within the distributed nodes with the certificate chain. Alternatively, the identity management module may receive a certificate signing request from the nodes within the distributed CTEE. After validating the integrity of the node, the identity module may issue a chained certificate to the node, which can be used by modules in the node to demonstrate membership within the CTEE.

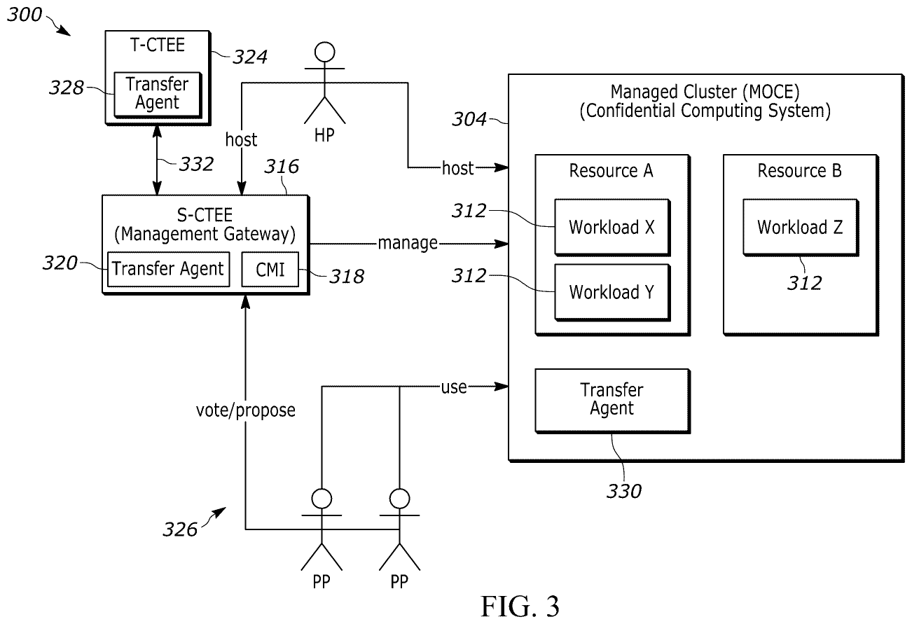

FIG. 3 illustrates an example CE 300 configured to implement MOCE transfer techniques according to the principles of the present disclosure. The CE 300 may be generally configured in a manner similar to the CE 200 of FIG. 2. Some elements shown in FIG. 2 are omitted from FIG. 3 for simplicity. For example, the CE 300 includes a confidential computing system 304 accessible by multiple developer entities (e.g., PPs, client computing devices, etc.). For example, different portions (e.g., workloads 312 associated with respective resources A, B, etc.) of a software application within the computing system 304 may be independently accessed by respective entities for developing and testing. In an example, the computing system 304 implements or is implemented by a confidential Kubernetes (K8s) cluster. Accordingly, the computing system 304 may be referred to as an MOCE, and the terms computing system and MOCE may be used interchangeable in the context of the system 304.

The CE 300 includes a CTEE 316 (which may be referred to as a source CTEE, or S-CTEE) configured to host/execute control logic for implementing a CMI 318. In some contexts, functionality of the S-CTEE 316 may be referred to as a management gateway (e.g., a trusted, consensus-based management gateway configured to implement and/or operate in accordance with a TEE). The S-CTEE 316 according to the present disclosure is configured to execute/implement all or portions of a transfer agent (e.g., an MOCE transfer agent) 320 as described below in more detail. All or portions of a transfer agent may be implemented by the T-CTEE 324, the S-CTEE 318, the MOCE 304, etc., each of which may be referred to as a transfer agent for simplicity. The S-CTEE 316 corresponds to CTEE currently being used to control/manage the MOCE 304 (i.e., a CTEE already set up, initiated, and executed as described above in FIG. 2).

In accordance with the principles of the present disclosure, control over the MOCE is transferred from the S-CTEE 316 to a target CTEE (T-CTEE) 324. As an example, the transfer process is describe below in the context of a scenario where a host party (HP) provides a security patch to update a software component of the S-CTEE 316. The description of the transfer process this scenario is merely for reasons of presentation and does not limit the application of the transfer process to other scenarios.

In an example transfer process, the hosting party HP launches the T-CTEE 324 in a manner similar to that described for the CE 200 (e.g., in a similar manner as used to launch the S-CTEE 316). In some examples, the configuration of the T-CTEE 324 may be different from the S-CTEE 316 one or more aspects. In other examples, the configuration of the T-CTEE 324 may be identical to the S-CTEE 316 (e.g., when a HP ceases operation and MOCEs must be transferred to substitute the current HP with a new HP). The HP may configure a set of potential S-CTEEs (e.g., by providing respective X.509 certificates of various CTEEs).

The HP informs at least one participating party (PP) of the MOCE to be transferred that the T-CTEE 324 is ready to receive transfer requests. The HP provides the PP with the X.509 certificate of the T-CTEE 324. One of the notified PPs then uses the CMI 318 to trigger a proposal to migrate the MOCE from the S-CTEE 316 to the T-CTEE 324 as shown at 326. For example, the proposal includes an endpoint (e.g., a fully qualified domain name and port) and the X.509 certificate of the T-CTEE 324 provided by the HP.

Each of the PPs reviews the migration proposal provided through the CMI 318. For example, the review may include using RA to establish trust in the T-CTEE 324 and inspect an attested configuration of the T-CTEE. Each of the PPs may approve or reject transfer of the MOCE to the T-CTEE 324 (e.g., by voting via the CMI 318). If no quorum is reached (e.g., too many PPs rejected the proposal), the MOCE transfer process is stopped, and control over the MOCE remains with the S-CTEE 316. For example, the transfer process may require approval from a predetermined minimum number of the PPs (e.g., a simple majority, a unanimous vote, etc.).

In response to quorum being reached (i.e., a sufficient number of the PPs approved the transfer process), the S-CTEE 316 initiates/executes the MOCE transfer agent 320, which is configured to implement the process for transferring the MOCE from the S-CTEE 316 to the T-CTEE 324. Prior to initiating the transfer process, the transfer agent 320 ensures that all ongoing management operations are completed and that no further management operations can be initiated by the PPs. For example, the transfer agent 320 may respond to incoming requests for management operations with status codes indicating that management operations cannot be completed (e.g., a 503 Service Unavailable HTTP status code for a representational state transfer (REST)-based CTEE API). The transfer agent 320 may respond in a similar manner to requests for updates from the MOCE itself. For example, a transfer agent 328 of the MOCE 304 may buffer updates and, in some examples, block operations within the MOCE 304 until the update is accepted by the T-CTEE 324 after the migration/transfer to the T-CTEE 324 is complete.

The transfer agent 320 is configured to establish a secure communication channel 332 between the S-CTEE 316 and the T-CTEE 324. For example, the channel 332 utilizes mutual authentication protocols between the S-CTEE 316 and the T-CTEE 324 by using respective X.509 certificates of the T-CTEE 324 and the S-CTEE 316 to perform transport layer security (TLS) mutual authentication. As an example, the T-CTEE 324 may implement a T-CTEE transfer agent 330, portions or functions of the transfer agent 320, etc.

The transfer agent 320 creates a snapshot of all configuration data stored in the S-CTEE 316 for the MOCE 304 to be transferred. The configuration data includes, but is not limited to: verifiable identities of owners of the MOCE 304; a specification of all resources and policies deployed on the MOCE 304; audit logs up until the point in time when the transfer process started (in cases where the audit log is stored externally, such as in an immutable database, the endpoint and access credentials may be included as a reference instead of the actual audit logs); and secret user credentials with administrative privileges for the MOCE 304 that were generated during MOCE setup and were used to implement consensus-driven management operations.

In some examples, the transfer agent 320 may be used to implement various compression techniques to minimize the amount of data that needs to be transmitted during the transfer process. The configuration data (e.g., a snapshot of the configuration data, either compressed or uncompressed) is transmitted over the secure communication channel 332 to the T-CTEE 324 (e.g., to the transfer agent of the T-CTEE 324).

Upon receipt of the configuration data, the T-CTEE 324 (e.g., a transfer agent of the T-CTEE 324) may optionally perform various snapshot data schema migration tasks to process and implement the configuration data, which may include, but are not limited to, decompression, integrity, and/or authenticity verification. The T-CTEE 324 restores/rebuilds MOCE-related data structures using the configuration data. In other words, the T-CTEE 324 sets up the MOCE 304 using the configuration data. Upon completion of restoring the MOCE 304, the T-CTEE 324 provides a notification to the S-CTEE 316 that the restoration of the MOCE 304 has been completed/was successful. Alternatively, if restoration of the MOCE 304 fails, the T-CTEE 324 can provide a notification to the S-CTEE 316 that the restoration of the MOCE 304 was unsuccessful.

Depending on whether the S-CTEE 316 receives a positive (successful restoration) or negative (unsuccessful restoration) notification from the T-CTEE 324, the S-CTEE 316 may either delete the MOCE 304 from a list of CEs managed by the S-CTEE 316 (e.g., in response to a positive notification) or retry/reinitiate the transfer process (e.g., in response to a negative notification). If a predetermined number of retries fail, the transfer is can be considered failed and the MOCE 304 remains under the control of the S-CTEE 316.

After successful migration/transfer of control of the MOCE 304 from the S-CTEE 316 to the T-CTEE 324, the S-CTEE 316 responds to requests from PPs related to the migrated MOCE 304 with a response indicating that the S-CTEE 316 no longer manages the MOCE 304. In some examples, the S-CTEE 316 may provide a notification to requesting PPs that the T-CTEE 324 is in control of the MOCE 304. For example, for a REST-based CTEE API, the notification may include a “301 Moved Permanently” status code including a URL or other identifier of the T-CTEE 324.

In some examples, the transfer process described herein can be implemented as a backup and restore (or recovery) mechanism. For example a CE such as the CE 200, CE 300, etc. may implement various backup and restore mechanisms to recover credentials for a user account that is created in the MOCE setup process and can be used to perform administrative actions on behalf of the PPs on the MOCE. Example backup and restore mechanisms may operate in accordance with secret sharing of the credentials and distributing shares over among the PPs. Systems and methods according to the present disclosure may be further configured to implement a backup and restore mechanism that uses transfer processes as described herein. For example, the contents of the MOCE (e.g., a snapshot of configuration data) can be transferred to a backup CTEE as backup data and transferred from the backup CTEE to a T-CTEE to restore/recover the MOCE (e.g., after complete failure of the S-CTEE, such as a failure caused by a cloud computing system outage). In other words, the T-CTEE becomes the new CTEE managing the restored MOCE.

Accordingly, a CE that implements a backup and restore mechanism according to the present disclosure may include: an S-CTEE for which a backup is created; a backup TEE (e.g., a dummy CTEE) that serves as storage for a snapshot of the S-CTEE/managed MOCE and may implement only an MOCE/transfer agent); and the T-CTEE that implements the version of the S-CTEE restored from the snapshot.

In this manner, both backup creation and restoration may be performed using the MOCE transfer processes as described herein. More specifically, a backup process transfers the snapshot from the S-CTEE to the backup TEE and the restoration process transfers the snapshot from the backup TEE to the T-CTEE. Further, policy-based auto-approval can be used to make the backup process a non-interactive process that can be performed on a periodical basis by a CTEE operating in the background.

By using a well-defined structured representation of a state of the managed MOCE, state descriptions can easily be compared between backups. As such, the restore process may be optimized such that only the difference/delta between the backups is transferred (i.e., rather than the entire snapshot), thereby reducing bandwidth costs and backup times.

The transfer process as described herein can be used to implement a CTEE update procedure (i.e., to perform software updates to imprinted or immutable CTEEs) as described below in more detail. As part of system setup, the HP deploys a CTEE registry on a system that is reachable over a network by the CTEEs described subsequently. The CTEE registry may be configured to accept network connections from authenticated CTEEs only (e.g., by means of TLS client authentication in which client certificates are issued by a HP-owned certificate authority (CA)). All CTEEs are configured with an endpoint of the CTEE registry and a root certificate of the HP-owned CA.

Upon startup, each CTEE registers with the CTEE registry over the network by providing at least the following information: a network endpoint where the CTEE can be reached for the purposes of MOCE transfer and remote attestation; and a description of the configuration of the CTEE.

After registering with the CTEE registry, the CTEEs each receive notifications over the network whenever a new CTEE is registered. When the HP discovers the need for upgrading a CTEE (e.g., a CTEE referred to as CTEE[i]), the HP launches a new CTEE[i+1] with the updated configuration. Upon launch, the CTEE[i+1] registers with the CTEE registry as described above. The PPs of the MOCEs controlled/managed by CTEE[i] are notified of the availability of CTEE[i+1] via the mechanism described above with respect to FIG. 3. The MOCE transfer process can then be initiated to transfer control of the MOCE from the CTEE[i] to the CTEE[i+1].

In some examples, systems and methods of the present disclosure may implement inter-CTEE attestation. For example, during review of the migration/transfer proposal as described above, the PPs perform RA to establish trust in the T-CTEE 324. Alternatively, this review can be delegated to the S-CTEE 316 since the PPs previously used RA to establish trust in the S-CTEE 316. The S-CTEE 316 can attach artifacts resulting from the RA, including the attested configuration of the T-CTEE 324, to the proposal. The PPs can then review the proposal and decide whether to approve the request. If a quorum is reached, the MOCE can be transferred to the T-CTEE 324 as described above. In an example, to maintain security during this process, the secret/key associated with the CTEEs (e.g., the private key belonging to the X.509 certificate) is not to be accessible to the HP and is confined within the S-CTEE 316. Otherwise, the HP could compromise security of the transfer process, such as by launching a time of check to time of use (TOCTTOU) attack (e.g., by launching a first, “good” T-CTEE and initiating the process such that RA occurs with the first T-CTEE, tearing down/removing the first T-CTEE and launching a second, malicious T-CTEE, and injecting the identify of the S-CTEE into the second T-CTEE, thereby allowing the PPs to connect to the second T-CTEE instead of the first T-CTEE.

In some examples, systems and methods of the present disclosure may implement policy-based auto-approval. For example, the S-CTEE 316 can be configured with a set of policies that define criteria on the artifacts generated by RA for automatic acceptance of a MOCE transfer request. The set of policies is subject to approval by a quorum of PPs. In response to a MOCE transfer request being initiated by a PP or the HP, RA is initiated by the S-CTEE 316. The policies are evaluated against the RA artifacts. If that evaluation has a positive outcome, the S-CTEE 316 transfers the MOCE to the T-CTEE 324, skipping the consensus-based approval, requiring no interaction with the PPs. However, when the PPs subsequently interact with the T-CTEE 324 (e.g., for initiating management operations), RA may still be required to establish trust in the T-CTEE 324 as well as a secure channel to the T-CTEE 324.

In some examples, systems and methods of the present disclosure may utilize systems that implement enclave owner/author and state based sealing techniques. In examples described herein, the S-CTEE 316 and the T-CTEE 324 use mutual TLS to establish a secure connection to transfer the MOCE snapshot data. As another example, a capability of TEE implementations called “enclave sealing” can be used. Enclave sealing specifically refers to the encryption of data in such a way that only the enclave that created (sealed) the data, or another enclave with the same identity and measurement, can decrypt (unseal) the. Accordingly, secure transfer of data between TEEs from the same author (e.g., the HP) and with the same measurement (cryptographic hash of code/data) can be performed. In this alternative implementation, the S-CTEE 316 uses the sealing key derived from the signature created by CTEE author and CTEE state to encrypt (or seal) the MOCE snapshot and sends the result to the T-CTEE 324. By design of the enclave owner mechanism, the T-CTEE 324 can decrypt (or unseal) the snapshot only if the T-CTEE 324 comes from the same author and has the same initial state (base configuration).

In some examples, systems and methods of the present disclosure may implement a distributed CTEE registry. As described above, a standalone CTEE registry can be launched by the HP to facilitate CTEE discovery. Alternatively, functionality for launching the CTEE registry can be directly integrated into the CTEEs. For that purpose, Group Communication protocols (e.g., atomic broadcast, gossip protocols, etc.) can be used to exchange CTEE advertisements. The capability of these protocols to also manage group membership allows the system to be shielded against attempts to take over MOCEs by attackers in the same way as the certificate-based methods described herein.

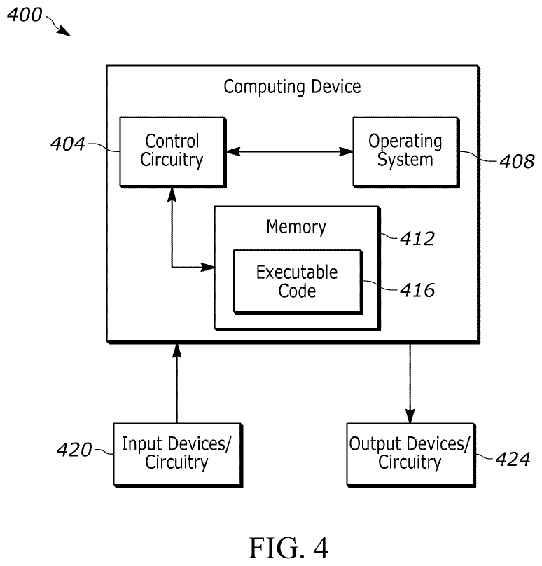

FIG. 4 shows a block diagram of an example computing device 400 configured to implement functions of the systems and methods described herein according to the present disclosure. For example, one or more of the computing devices 400 may implement or be implemented by the one or more components of the CE 300. Systems described herein may implement a single computing device, a plurality of computing devices, etc., configured to individually and/or collectively perform functions related to the systems and methods of the present disclosure. In an example, the S-CTEE 316, the T-CTEE 324, and/or the MOCE/computing system 304 may implement or include one or more of the computing devices 400.

The computing device 400 may include control circuitry 404 that may be, for example, one or more processors or processing devices, a central processing unit processor (a, CPU, such as a CPU configured to operate a protected memory space in accordance with a TEE), an integrated circuit or any suitable computing or computational device, an operating system 408, a memory 412, executable code 416, input devices or circuitry 420, and output devices or circuitry 424. The control circuitry 404 (or one or more controllers or processors, possibly across multiple units or devices) may be configured to implement functions of the systems and methods described herein. More than one of the computing devices 400 may be included in, and one or more of the computing devices 400 may act as the components of, a system according to embodiments of the disclosure. Various components of the computing device 400 may be implemented with same or different circuitry, same or different processors or processing devices, etc.

The operating system 408 may be or may include any code segment (e.g., one similar to the executable code 416 described herein) designed and/or configured to perform tasks involving coordination, scheduling, arbitration, supervising, controlling or otherwise managing operation of the control circuitry 404 (e.g., scheduling execution of software programs or tasks or enabling software programs or other hardware modules or units to communicate). The operating system 408 may be a commercial operating system. The operating system 408 may be an optional component (e.g., in some embodiments, a system may include a computing device that does not require or include the operating system 408). For example, a computer system may be, or may include, a microcontroller, an application specific circuit (ASIC), a field programmable array (FPGA), network controller (e.g., CAN bus controller), associated transceiver, system on a chip (SOC), and/or any combination thereof that may be used without an operating system.

The memory 412 may be or may include, for example, Random Access Memory (RAM), read only memory (ROM), Dynamic RAM (DRAM), Synchronous DRAM (SD-RAM), a double data rate (DDR) memory chip, Flash memory, volatile memory, non-volatile memory, cache memory, a buffer, a short-term memory unit, a long-term memory unit, or other suitable memory units or storage units. The memory 412 may be or may include a plurality of memory units, which may correspond to same or different types of memory or memory circuitry. The memory 412 may be a computer or processor non-transitory readable medium, or a computer non-transitory storage medium, e.g., RAM.

The executable code 416 may be any executable code, e.g., an application, a program, a process, task, or script. The executable code 416 may be executed by the control circuitry 404, possibly under control of the operating system 408. Although, for the sake of clarity, a single item of the executable code 416 is shown, a system according to some embodiments of the disclosure may include a plurality of executable code segments similar to the executable code 416 that may be loaded into the memory 412 and cause the control circuitry 404 to carry out methods described herein. Where applicable, the terms “process” and “executable code” may be used interchangeably herein. For example, verification, validation and/or authentication of a process may mean verification, validation and/or authentication of executable code.

In some examples, the memory 412 may include non-volatile memory having the storage capacity of a storage system. In other examples, the computing device 400 may include or communicate with a storage system and/or database. Such a storage system may include, for example, flash memory, memory that is internal to, or embedded in, a micro controller or chip, a hard disk drive, a solid-state drive, a CD-Recordable (CD-R) drive, a Blu-ray disk (BD), a universal serial bus (USB) device or other suitable removable and/or fixed storage unit. Content may be stored in the storage system and loaded from the storage system into the memory 412 where it may be processed by the control circuitry 404.

The input circuitry 420 may be or may include any suitable input devices, components, or systems, e.g., physical sensors such as accelerometers, thermometers, microphones, analog to digital converters, etc., a detachable keyboard or keypad, a mouse, etc. The output circuitry 424 may include one or more (possibly detachable) displays or monitors, motors, servo motors, speakers and/or any other suitable output devices. Any applicable input/output (I/O) devices may be connected to the control circuitry 404. For example, a wired or wireless network interface card (NIC), a universal serial bus (USB) device, or external storage device may be included in the input circuitry 420 and/or the output circuitry 424. It will be recognized that any suitable number of input devices and output devices may be operatively connected to the control circuitry 404. For example, the input circuitry 420 and the output circuitry 424 may be used by a technician or engineer in order to connect to the control circuitry 404, update software, and the like.

Embodiments may include an article such as a computer or processor non-transitory readable medium, or a computer or processor non-transitory storage medium, such as for example memory, a disk drive, or USB flash memory, encoding, including or storing instructions (e.g., computer-executable instructions, which, when executed by a processor or controller, carry out methods disclosed herein), a storage medium such as the memory 412, computer-executable instructions such as the executable code 416, and a controller such as the control circuitry 404.

The storage medium may include, but is not limited to, any type of disk including magneto-optical disks, semiconductor devices such as read-only memories (ROMs), random access memories (RAMs), such as a dynamic RAM (DRAM), erasable programmable read-only memories (EPROMs), flash memories, electrically erasable programmable read-only memories (EEPROMs), magnetic or optical cards, or any type of media suitable for storing electronic instructions, including programmable storage devices.

Embodiments of the disclosure may include components such as, but not limited to, a plurality of central processing units (CPU) or any other suitable multi-purpose or specific processors or controllers (e.g., controllers similar to the control circuitry 404), a plurality of input units, a plurality of output units, a plurality of memory units, and a plurality of storage units, etc. A system may additionally include other suitable hardware components and/or software components. In some embodiments, a system may include or may be, for example, a personal computer, a desktop computer, a mobile computer, a laptop computer, a notebook computer, a terminal, a workstation, a server computer, a Personal Digital Assistant (PDA) device, a tablet computer, a network device, or any other suitable computing device.

In some embodiments, a system may include or may be, for example, a plurality of components that include a respective plurality of central processing units, e.g., a plurality of CPUs as described, a plurality of CPUs embedded in an on-board system or network, a plurality of chips, FPGAs or SOCs, microprocessors, transceivers, microcontrollers, a plurality of computer or network devices, any other suitable computing device, and/or any combination thereof. For example, a system as described herein may include one or more devices such as the control circuitry 404.

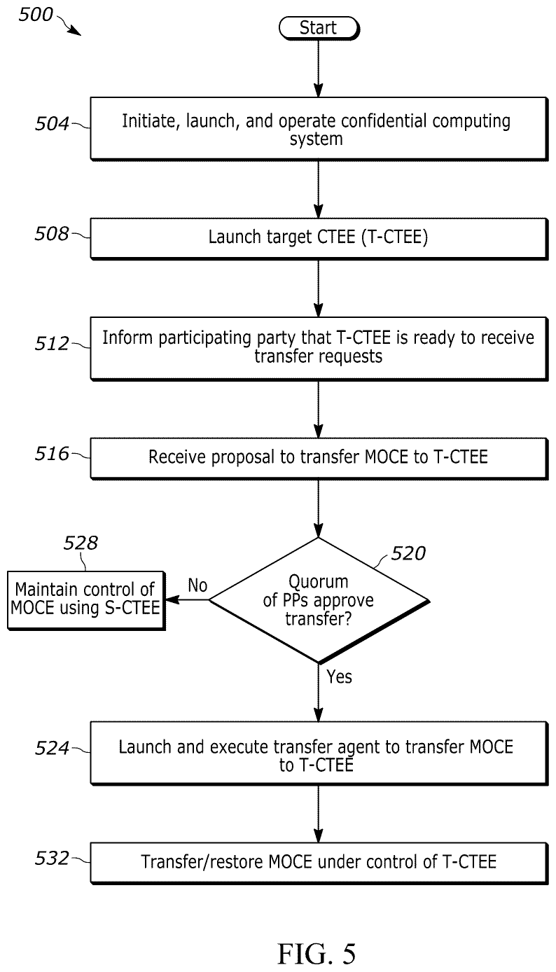

FIG. 5 illustrates steps of an example method 500 for performing an MOCE transfer process in a confidential, cooperative computing environment according to the principles of the present disclosure. For example, one or more computing devices, processors or processing devices, etc. are configured to execute instructions to implement the method 500, such as one or more of processors of the systems described herein. In an example, the CE 300 implements all or portions of the method 500.

At 504, the method 500 includes initiating and operating a confidential computing environment/system to facilitate cooperative computing. For example, a TEE is launched on a confidential computing system, an interface (e.g., an API, CMI, etc. as described herein) is executed to provide access for management functionality to PPs (e.g., via a management gateway), a setup process is initiated, assessed, and approved by PPs, and a build process is launched to being operation of a confidential computing system (e.g., a managed cluster/MOCE). As described in this example, the TEE is a source-CTEE (S-CTEE).

At 508, the method 500 includes launching a target-CTEE (T-CTEE). For example, a hosting party (HP) launches the T-CTEE. At 512 the method 500 includes informing at least one participating party (PP) associated with the S-CTEE that the T-CTEE is ready to receive transfer requests.

At 516, the method 500 includes receiving (e.g., via a CMI of the S-CTEE), from a PP, a proposal to transfer/migrate the MOCE to the T-CTEE. At 520, the method 500 includes determining whether the proposal is approved by the PPs. For example, determining whether the proposal is approved by the PPs may including determining, at the S-CTEE, whether a quorum (e.g., a simple majority or other predetermined minimum number) of the PPs approved (e.g., voted in favor of) transfer of the MOCE to the T-CTEE. If true, method 500 continues to 524. If false, the method 500 continues to 528. At 528, the method 500 includes maintaining control of the MOCE using the S-CTEE.

At 524, the method 500 includes launching and executing, at the S-CTEE, an MOCE transfer agent to transfer the MOCE to the T-CTEE. For example, launching the transfer agent may include completing and/or stopping management operations, establishing a secure communication channel with the T-CTEE, creating a snapshot of configuration data for the MOCE to be transferred, and transmitting/sending the configuration data to the T-CTEE via the secure communication channel.

At 532, the method 500 includes transferring/restoring the MOCE under the control of the T-CTEE. Transferring/restoring the MOCE may include, but is not limited to, performing various data migration tasks, sending an acknowledgement to the S-CTEE that the transfer/restoration of the MOCE was successful, etc. Additionally restoring may include restoring MOCE-related data structures internal to the T-CTEE. If the transferring/restoring was successful, the S-CTEE may delete the transferred MOCE from a list of CEs managed by the S-CTEE. If the transferring/restoring was not successful, the S-CTEE may retry the transfer process one or more times.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

The various steps and logic performed herein can be executed with non-volatile storage, memory, and processors. Non-volatile storage may include one or more persistent data storage devices such as a hard drive, optical drive, tape drive, non-volatile solid-state device, cloud storage or any other device configured to persistently store information. Processor may include one or more devices selected from high-performance computing (HPC) systems including high-performance cores, microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on computer-executable instructions residing in memory. Memory may include a single memory device or a number of memory devices including, but not limited to, random access memory (RAM), volatile memory, non-volatile memory, static random access memory (SRAM), dynamic random access memory (DRAM), flash memory, cache memory, or any other device configured to store information.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrases “at least one of A, B, and C” and “at least one of A, B, or C” should be construed to mean a logical (A OR B OR C), using a non-exclusive logical OR, and should not be construed to mean “at least one of A, at least one of B, and at least one of C.”

The terms “a,” “an,” “the,” and “said” as used herein in connection with any type of processing component configured to perform various functions may refer to one processing component configured to perform each and every function, or a plurality of processing components collectively configured to perform each of the various functions. By way of example, “A processor” configured to perform actions A, B, and C may refer to one or more processors configured to perform actions A, B, and C. In addition, “a processor” (or, “a processing device,” “a computing device,” and so on) configured to perform actions A, B, and C may also refer to a first processor configured to perform actions A and B, and a second processor configured to perform action C. Further, “A processor” configured to perform actions A, B, and C may also refer to a first processor configured to perform action A, a second processor configured to perform action B, and a third processor configured to perform action C.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

What is claimed is:

1. A method for performing a transfer of a multi-owned computing environment (MOCE), the method comprising, using one or more computing devices:
establishing a confidential computing system in a trusted execution environment (TEE) under control of a source controller configured to implement a transfer agent;
launching a target controller separate from the source controller;
in response to receiving a proposal to transfer control of the confidential computing system from the source controller to the target controller, determining whether a predetermined number of participating parties (PPs) associated with the confidential computing system approve of the transfer of control;
in response to determining that the predetermined number of PPs approve of the transfer of control, launching the transfer agent at the source controller; and
transferring control of the MOCE to the target controller using the transfer agent.

2. The method of claim 1, further comprising, prior to receiving the proposal, providing a notification to at least one of the PPs that the target controller is ready to receive transfer requests.

3. The method of claim 1, wherein transferring control of the MOCE includes at least one of:
prior to transferring control, completing management operations associated with the MOCE;
establishing a secure communication channel between the source controller and the target controller;
creating a snapshot of configuration data associated with the MOCE; and
transmitting the snapshot of configuration data to the target controller.

4. The method of claim 3, wherein transferring control of the MOCE further includes at least one of:
at the target controller, restoring data structures of the MOCE using the configuration data; and
transmitting, from the target controller to the source controller, a notification indicating whether restoration of the data structures of the MOCE was successful.

5. The method of claim 4, further comprising, at the source controller in response to receiving a notification that restoration of the data structures was successful, deleting the MOCE from a list of computing environments managed by the source controller.

6. The method of claim 4, further comprising, at the source controller in response to receiving a notification that restoration of the data structures was not successful, attempting another transfer of control of the MOCE to the target controller.

7. The method of claim 6, further comprising, at the source controller:
compressing the snapshot of the configuration data; and
transmitting the compressed snapshot to the target controller.

8. The method of claim 1, wherein transferring control of the MOCE includes at least one of:
prior to transferring control, completing management operations associated with the MOCE;
creating a snapshot of configuration data associated with the MOCE; and
storing the snapshot on at least one of a second TEE and a secure storage.

9. The method of claim 8, further comprising, at the target controller:
retrieving one snapshot from the at least one of the second TEE and the secure storage; and
restoring data structures of the MOCE using the configuration data.

10. The method of claim 1, further comprising, at the source controller:
creating a first snapshot of configuration data associated with the MOCE;
retrieving a second snapshot of configuration data associated with the MOCE from at least one of a second TEE and a secure storage;
computing a difference between the second snapshot and the first snapshot; and
storing the computed difference on the one of the second TEE and the secure storage.

11. The method of claim 1, further comprising:
creating, at a hosting party (HP), a registry of a plurality of source controllers;
in response to receiving an updated version of the source controller, informing the plurality of source controllers through the registry of the launching of a target controller with an updated version; and
in response to receiving information associated with the new target controller, initiating through voting by the PPs, transfer of the MOCE to the target controller.

12. The method of claim 1, further comprising, at a source controller in response to launching a target controller separate from the source controller:
performing a remote attestation procedure with the target controller to obtain an attestation report;
in response to receiving a proposal to transfer control of the confidential computing system from the source controller to the target controller, transmitting the attestation report to the plurality of the PPs; and
in response to receiving votes from the PPs, determining whether a predetermined number of the PPs associated with the confidential computing system approve of the transfer of control;
in response to determining that the predetermined number of PPs approve of the transfer of control, launching the transfer agent at the source controller; and
transferring control of the MOCE to the target controller using the transfer agent.

13. The method of claim 1, further comprising, in accordance with an automatic update policy approved by a plurality of PPs stored on the source controller:
in response to receiving initiation of MOCE transfer from a PP of the plurality of PPs at the source controller, obtaining a remote attestation report associated with the target controller using a remote attestation process between the source controller and the target controller; and
in response to comparing the remote attestation report with the automatic update policy, triggering a transfer of the MOCE to the target controller.

14. The method of claim 13 further comprising:
establishing a distributed registry of a plurality of source controllers; and
in response to addition of a new controller to the plurality of source controllers, using group communication protocols to transmit information associated with the new controller.

15. The method of claim 13, further comprising:
establishing a registry of a plurality of source controllers;
in response to addition of a new controller to the plurality of source controllers, receiving information associated with the new controller;
obtaining a remote attestation report of the new controller; and
in response to comparing the remote attestation report with the automatic update policy, triggering a transfer of the MOCE to the target controller.

16. A system configured to perform a transfer of a multi-owned computing environment (MOCE), the system comprising:
one or more computing devices configured to
establish a confidential computing system in a trusted execution environment (TEE) under control of a source controller configured to implement a transfer agent,
launch a target controller separate from the source controller,
in response to receiving a proposal to transfer control of the confidential computing system from the source controller to the target controller, determine whether a predetermined number of participating parties (PPs) associated with the confidential computing system approve of the transfer of control,
in response to determining that the predetermined number of PPs approve of the transfer of control, launch the transfer agent at the source controller, and
transfer control of the MOCE to the target controller using the transfer agent.

17. The system of claim 16, wherein the one or more computing devices are further configured to, prior to receiving the proposal, provide a notification to at least one of the PPs that the target controller is ready to receive transfer requests.

18. The system of claim 16, wherein transferring control of the MOCE includes at least one of:
prior to transferring control, completing management operations associated with the MOCE;
establishing a secure communication channel between the source controller and the target controller;
creating a snapshot of configuration data associated with the MOCE; and
transmitting the snapshot of configuration data to the target controller.

19. The system of claim 18, wherein transferring control of the MOCE further includes at least one of:
at the target controller, restoring data structures of the MOCE using the configuration data; and
transmitting, from the target controller to the source controller, a notification indicating whether restoration of the data structures of the MOCE was successful.

20. The system of claim 19, wherein the one or more computing devices are further configured to, at the source controller in response to receiving a notification that restoration of the data structures was successful, delete the MOCE from a list of computing environments managed by the source controller.
